(19) United States
(12) Patent Application Publication
(10) Pub. No.: US 2026/0093264 A1
(43) Pub. Date: Apr. 2, 2026

(54) SYSTEM AND METHOD FOR OPTIMIZING PATH EXPLORATION PARAMETERS BASED ON DEEP REINFORCEMENT LEARNING

(71) Applicant: SHANGHAI JIAO TONG UNIVERSITY, Shanghai (CN)

(72) Inventors: Yafei Wang, Shanghai (CN); Xulei Liu, Shanghai (CN); Yichen Zhang, Shanghai (CN); Zhisong Zhou, Shanghai (CN); Zexing Li, Shanghai (CN); Bowen Wang, Shanghai (CN)

(73) Assignee: SHANGHAI JIAO TONG UNIVERSITY, Shanghai (CN)

(21) Appl. No.: 19/404,078

(22) Filed: Dec. 1, 2025

(30) Foreign Application Priority Data
Jan. 3, 2025 (CN) 202510010567.5

(51) Int. Cl. G05D 1/644; G05D 1/622; G05D 101/15; G05D 105/05; G05D 105/80

(52) U.S. Cl. CPC G05D 1/644; G05D 1/622; G05D 2101/15; G05D 2105/05; G05D 2105/87

(57) ABSTRACT

The present invention relates to the technical field of path planning, and provides a deep reinforcement learning-based path exploration parameter optimization system. The system comprises: a variable parameter path planning module, configured to perform node exploration based on a deep reinforcement learning network, conduct collision detection on child nodes in a child node set, calculate cost values for all child nodes, and finally generate a loading and parking path using a Reeds-Shepp curve; an environmental state space modeling module, configured to perform regional division of obstacles around a current node and conduct environmental state space modeling; and a deep learning parameter optimization module, configured to construct a deep learning network to compute an optimal step size and an optimal steering angle, build a reward function to optimize the deep learning network, and simultaneously execute a training process of the deep learning network.

### CROSS-REFERENCE TO RELATED APPLICATIONS

This application claims priority to Chinese Patent Application Ser. No. CN202510010567.5 filed on 3 Jan. 2025.

### TECHNICAL FIELD

The present invention relates to the technical field of path planning, and particularly to a deep reinforcement learning-based path exploration parameter optimization system and method.

### BACKGROUND TECHNIQUE

The application of autonomous driving technology for mining trucks will significantly enhance the efficiency of mining resource extraction and transportation, while also improving safety. To achieve unmanned operation of mining trucks, an efficient path planning system is essential. This system should be capable of generating safe and efficient driving paths tailored to operational requirements and the mining environment.

Mining operation areas typically feature complex terrain, rugged roads, numerous obstacles, and irregular topography, resulting in limited navigable areas and posing multiple challenges for path planning. Additionally, mining trucks must strictly control their heading angle during loading operations to ensure safety and efficiency, meaning path planning must account for terminal pose constraints, further increasing the difficulty of problem-solving. In complex and dynamic mining operation scenarios, existing path planning methods still face issues of low search efficiency and poor path quality.

Graph-based search methods, such as the Hybrid A* algorithm, although capable of generating paths with precise terminal poses, suffer from slow computation speeds and low planning efficiency. Sampling-based methods, like the rapidly-exploring random tree algorithm, often produce paths that do not conform to the motion characteristics of unmanned mining trucks, making them difficult to apply directly. The core reason for the insufficient search efficiency of the aforementioned algorithms lies in their relatively fixed path exploration parameters, which struggle to adapt to complex and dynamic mining operation scenarios. Furthermore, although manual rules can be set to adjust exploration parameters, the irregular distribution of mine debris makes it difficult for predefined rules to accurately adapt to every scenario, and the existence of numerous parameters requiring extensive tuning results in high maintenance costs.

Based on the limitations of the aforementioned methods, there is an urgent need for a novel path planning algorithm that can both enhance planning speed and ensure strong generalization capability to adapt to complex mining environments.

### SUMMARY OF THE INVENTION

In response to the above issues, the objective of the present invention is to provide a deep reinforcement learning-based path exploration parameter optimization system and method. By optimizing the exploration parameters in the path planning method through a deep reinforcement learning network, adaptive optimization of exploration parameters in complex scenarios is achieved, thereby improving search efficiency and path quality while reducing the cost of parameter tuning and maintenance. By analyzing environmental obstacle information, a state space that considers obstacle distribution is established, thereby enhancing the deep reinforcement learning network's understanding of the environment, improving generalization in complex and dynamic scenarios, and reducing reliance on maps and overfitting.

The above-described objective of the present invention is achieved through the following technical solutions:

A deep reinforcement learning-based path exploration parameter optimization system, comprising:
A variable parameter path planning module, configured to: generate an optimal step length and an optimal steering angle based on a deep reinforcement learning network according to a current node and environmental information; construct a fixed steering angle set; perform node exploration by generating a child node set through combining the optimal step length with the fixed steering angle set and generating a steering angle-optimized child node by combining the optimal step length with the optimal steering angle and adding it to the child node set; perform collision detection on the child nodes in the child node set and calculate cost values of all the child nodes; and finally generate a loading and parking path using a Reeds-Shepp curve;
An environmental state space modeling module, configured to perform regional division of obstacles surrounding the current node and conduct environmental state space modeling;
A deep learning parameter optimization module, configured to construct a deep learning network to calculate the optimal step length and the optimal steering angle, build a reward function to optimize the deep learning network, and simultaneously execute a training process of the deep learning network.

Furthermore, in the variable parameter path planning module, generating the optimal step length and optimal steering angle based on the deep reinforcement learning network according to the current node and environmental information, constructing the fixed steering angle set, and performing node exploration by combining the optimal step length with the fixed steering angle set to generate the child node set and combining the optimal step length with the optimal steering angle to generate the steering angle-optimized child node which is added to the child node set, is specifically implemented as:

Assuming the current node is N_{c}(x_{c}, y_{c}, φ_{c}), where x_{c}, y_{c} are the coordinates and φ_{c} is the heading angle, the following is established based on the motion characteristics of the unmanned mining truck:

$$\{ \begin{matrix}{x}_{s} = {x}_{c} + d * l cos {φ}_{c} \\ {y}_{s} = {y}_{c} + d * l sin {φ}_{c} \\ {φ}_{s} = {φ}_{c} + l * \frac{tan δ}{{L}_{w}}\end{matrix} \qquad ( 1 )$$

Where Nₛ(xₛ, yₛ, φₛ) is the next child node explored from the current node, xₛ, yₛ are the position coordinates, φₛ is the heading angle, dₛ∈{−1,1} represents the expansion direction of the current node including backward or forward, δ and l represent the steering angle and step length of node expansion respectively, and L_{w} is the wheelbase of the unmanned mining truck.

the optimal step length generated for the current node and the environmental information by the deep reinforcement learning network, and the optimal steering angle; and the fixed steering angle set Δ₁={δ₁, . . . , δ_{N}_{₃}} is constructed by uniform sampling. For a fixed steering angle δᵢ(where i=1, 2, . . . , N₃), the calculation method is as follows:

$${δ}_{i} = - {δ}_{max} + ( i - 1 ) * \frac{2 * {δ}_{max}}{{N}_{3} - 1} \qquad ( 2 )$$

Where δₘₐₓ is the maximum steering angle that the mining truck can execute, and N₃ is the number of steering angles constructed;

Node exploration is performed through a two-step process comprising step size optimization and steering angle optimization. In the first step, the optimal step length L_{best} and all sampled fixed steering angles in the fixed steering angle set Δ₁ are substituted into Formula (1), thereby generating the child node set N for fixed steering angle exploration. The number of child nodes in the child node set N is the same as the number of sampled angles in the fixed steering angle set Δ₁, which is N₃. In the second step, the optimal step length L_{best} and the optimal steering angle δ_{best} are substituted into Formula (1) to generate the steering angle-optimized child node N_{best}, which is then added to the child node set N.

In the variable parameter path planning module, performing collision detection on the child nodes in the child node set and calculating cost values of all the child nodes specifically comprises:

Performing collision detection on all child nodes in the child node set N by covering the mining truck with two enveloping circles, sampling along the path from the current node to the explored child nodes, determining whether the distance to any obstacle grid is smaller than the radius of the enveloping circles; if so, the child node is considered infeasible and is removed from the child node set N;

The cost value of all explored child nodes is calculated using f(Nₛ)=g(Nₛ)+wₕ×h(Nₛ), where g(Nₛ) represents the actual cost consumed during the movement of the mining truck from the starting point to the explored child node, h(Nₛ) represents the estimated cost from the explored child node to the target point, and wₕ is the weight of the estimated cost.

Wherein the actual consumption cost g(Nₛ) is:

$$g ( {N}_{s} ) = g ( {N}_{c} ) + {w}_{1} {g}_{dis} ( {N}_{s} ) + {w}_{2} {g}_{back} ( {N}_{s} ) + {w}_{3} {g}_{switch} ( {N}_{s} ) + {w}_{4} {g}_{steer} ( {N}_{s} ) + {w}_{5} {g}_{change} ( {N}_{s} ) \qquad ( 3 )$$

In the above formula, g(Nₛ) incorporates five metrics based on the cost of the current node g(N_{c}): g_{dis}(Nₛ) denotes the distance from the current node N_{c} to the child node Nₛ in the iterative search; g_{back}(Nₛ) represents the reversing cost; g_{switch}(Nₛ) indicates the mode switch cost; gₛₜₑₑᵣ(Nₛ) denotes the steering cost; g_{change}(Nₛ) represents the steering change cost; and wᵢ, where i=1, . . . ,5, are the weight coefficients.

In the variable parameter path planning module, generating the loading and parking path using a Reeds-Shepp curve specifically comprises:

When the distance between the current node N_{c}(x, y_{c}, φ_{c}) and the target point N_{g} is less than a threshold Lₜ, a plurality of candidate loading and parking path curves from the current node N_{c}(x_{c}, y_{c}, φ_{c}) to the target point N_{g} are generated using the Reeds-Shepp curve. The node costs along the curves are calculated by Formula (3), and the curves are sorted based on their costs. The path with the minimum cost is selected, and the global path is obtained through backtracking.

If all candidate loading and parking path curves are in collision, the process proceeds to the node exploration step.

In the environmental state space modeling module, performing regional division of obstacles surrounding the current node specifically comprises:

The space surrounding the current node N_{c}(x_{c}, y_{c}, φ_{c}) is divided into 8 sectors D= {D₁, . . . , D₈} by angular divisions. Within each sector, let d_{obs}_{ᵢ}(where i=1,2, . . . ,8) represent the minimum distance between obstacles and the mining truck in the i-th sector.)

In the environmental state space modeling module, conducting environmental state space modeling specifically comprises:

The state space S is defined as follows:

$$S = ( {d}_{start} , {ϕ}_{start} , {d}_{goal} , {ϕ}_{goal} , {φ}_{goal} - ϕ , {S}_{position} , {N}_{obs} , {d}_{{obs}_{i}} ) \qquad ( 4 )$$

Wherein Sₚₒₛᵢₜᵢₒₙ represents the coordinates of the current node, dₛₜₐᵣₜ denotes the distance from the starting point relative to the current node, φₛₜₐᵣₜ indicates the relative angular orientation of the starting point in a coordinate system with the current node as the origin and the heading direction as the x-axis, d_{goal} denotes the distance from the target point relative to the current node, φ_{goal} indicates the relative angular orientation of the target point in a coordinate system with the current node as the origin and the heading direction as the x-axis, φ_{goal}-φrepresents the direction of the target loading position in a coordinate system with the current node as the origin and the heading direction as the x-axis, N_{obs} denotes the number of obstacles within a given range of the current node, and d_{obs}_{ᵢ}=1,2, . . . , 8 represents the minimum distance between obstacles and the mining truck in the i-th sector.

In the deep learning parameter optimization module, constructing the deep learning network to calculate the optimal step length and the optimal steering angle specifically comprises:

The DQN algorithm is employed to train the deep learning network, with the action space consisting of combinations of candidate optimal step lengths δᵣₗ and candidate optimal steering angles lᵣₗ during expansion, i.e., the action space comprises all possible combinations of (δᵣₗ, lᵣₗ);

The DQN algorithm utilizes two networks with identical structures but different parameters for training: a training network Q_{π} used to compute the Q-value for policy selection and iteratively update the Q-values; and a target network Q′_{π} used to compute the Q-value of the next state in the temporal difference target (TD Target). The loss function Loss of the DQN algorithm is designed as follows:

$$Loss = \frac{1}{N} {\sum }_{i} {( {r}_{i} + γ {max}_{{a}_{i}^{′}} {Q}_{π}^{′} ( {s}_{i}^{′} , {a}_{i}^{′} ) - {Q}_{π} ( {s}_{i} , {a}_{i} ) )}^{2} \qquad ( 5 )$$

Wherein (sᵢ, aᵢ, rᵢ, s′ᵢ) represents a set of state transition data obtained during training, including the current state sᵢ, the current action aᵢ, the reward rᵢ obtained after taking the

$$action {a}_{i}^{′} ,$$

and the next state

$${s}_{i}^{′}$$

obtained atter interacting with the environment by taking the action; γ is an adjustable discount factor;

Both the target network

$${Q}_{π}^{′}$$

and the training network Q_{π} are constructed using three fully connected layers, each containing 32 neurons. The outputs of the first two fully connected layers are fed into an activation function before being passed to the next fully connected layer, with the PReLU activation function being employed. The final fully connected layer directly outputs the Q-value for each action, including steering angles and step lengths. The steering angle and step length with the highest Q-value are ultimately selected as the optimized exploration parameters, comprising the optimal step length and the optimal steering angle.

In that, in the deep learning parameter optimization module, constructing a reward function to optimize the deep learning network specifically comprises:

The reward function involves a target approach reward r_{g}, an obstacle avoidance reward rₒ, an exploration cost rₜ, and a smoothness reward rₛ:

The target approach reward r_{g} is defined as follows:

$${r}_{g} = \{ \begin{matrix}{r}_{success} & Reeds - shepp connection success \\ {w}_{g} ( {l}_{c} - {l}_{b} ) & Reeds - shepp connection failed\end{matrix} \qquad ( 6 )$$

Wherein w_{g} is an adjustable weight, l_{c} is the Euclidean distance from the current node N_{c} to the target point N_{g} in the current iteration round, l_{b} is the Euclidean distance from the steering angle-optimized child node N_{best} to the target point N_{g}, and r_{success} is a fixed reward given when successfully connected to the destination, indicating that the mining truck has reached the target point.

The obstacle avoidance reward rₒ is defined as follows:

$${r}_{{o}_{1}} = \{ \begin{matrix}{r}_{collision} , & {d}_{{obs}_{i}} \leq d \\ \frac{{w}_{1}}{{d}_{{obs}_{i}}} , & {d}_{c} \leq {d}_{{obs}_{i}} \leq 2 {d}_{c} \\ \frac{{w}_{2}}{{( {d}_{{obs}_{i}} )}^{4}} , & 2 {d}_{c} \leq {d}_{{obs}_{i}} \leq 10 {d}_{c} \\ 0 , & else\end{matrix} \qquad ( 7 )$$

Wherein rₒ_{ᵢ} represents the obstacle avoidance reward in the i-th sector, w₁ and w₂ are adjustable weight coefficients respectively. A distance threshold d_{c} is designed, where d_{obs}_{ᵢ}≤d_{c} is considered a collision, returning a large penalty constant r_{collision}; when d_{c}≤d_{obs}_{ᵢ}≤2d_{c}, it is considered a dangerous situation, returning a relatively large penalty function; when 2d_{c}≤d_{obs}_{ᵢ}≤10d_{c}, it is considered risky, returning a relatively small penalty function; when d_{obs}_{ᵢ}≥10d_{c}, it is considered safe, and no penalty is returned. The overall obstacle avoidance reward rₒ satisfies the following formula:

$${r}_{o} = {\sum }_{n = 1}^{8} - {r}_{{o}_{i}} \qquad ( 8 )$$

The exploration cost rₜ is defined as follows:

$${r}_{t} = - Timeconstant \qquad ( 9 )$$

Wherein TimeConstant is a fixed penalty cost constant set for each step, guiding the mining truck to approach the destination more rapidly and preventing meaningless exploration, with the cost set as a negative value;

The smoothness reward rₛ is defined as follows:

$${r}_{s} = - {w}_{3} \vert {δ}_{rl} \vert - {w}_{4} {e}^{- \frac{1}{{l}_{rl}}} \vert {δ}_{rl} - {δ}_{c} \vert \qquad ( 10 )$$

Wherein δ_{c} represents the steering angle corresponding to the current node N_{c} generated in the current search iteration round, δᵣₗ corresponds to the optimal steering angle generated by the deep reinforcement learning network in the current search iteration round, lᵣₗ represents the optimal step length generated by the deep reinforcement learning network in the current search iteration round, and w₃ and w₄ are adjustable coefficients respectively;

The final reward function is as follows:

$$R = {r}_{g} + {r}_{o} + {r}_{t} + {r}_{s} \qquad ( 11 )$$

In the deep learning parameter optimization module, executing the training process of the deep learning network specifically comprises:

First, randomly selecting appropriate starting and target points on the map based on actual production data and performing path planning; during planning, optimizing path planning parameters through reinforcement learning, thereby forming multiple sets of state transition sample data and adding them to a replay buffer; during the training process, randomly selecting batches of data from the replay buffer and updating the parameters of the estimation network Q_{π} according to the loss function; after a certain number of iterations, copying the parameters of the training network Q_{π} to the target network Q′_{π}, thereby completing one learning process.

A deep reinforcement learning-based path exploration parameter optimization method executed by the deep reinforcement learning-based path exploration parameter optimization system according to any one of claims 1-8, characterized by comprising the following steps:
S1: Generating an optimal step length and an optimal steering angle based on a deep reinforcement learning network according to a current node and environmental information, and constructing a fixed steering angle set; performing node exploration by combining the optimal step length with the fixed steering angle set to generate a child node set, and combining the optimal step length with the optimal steering angle to generate a steering angle-optimized child node which is added to the child node set;
S2: Performing collision detection on the child nodes in the child node set and calculating cost values of all the child nodes;
S3: Obtaining the child node with the lowest cost value in each iteration round of the search process as the final selected next node of the current node;
S4: When the distance from the current node to the target point is less than a set threshold, generating a loading and parking path using a Reeds-Shepp curve, and generating a planned path through node backtracking.

Compared with the prior art, the present invention includes at least one of the following beneficial effects:

### (1) Enhances Search Efficiency and Path Quality

Mining operations involve irregularly distributed debris and mountainous terrain, resulting in varying exploration difficulties and navigable areas across different regions. Existing path planning methods with fixed exploration parameters suffer from parameter mismatch, leading to reduced search efficiency. The present invention addresses this by employing a deep reinforcement learning network to optimize path exploration parameters. It automatically optimizes and adjusts exploration parameters based on environmental information, generating nodes with lower costs, thereby improving both search efficiency and path quality.

### (2) Adaptability to Complex and Dynamic Mining Operation Scenarios

Mining operation scenarios undergo dynamic changes as work progresses. Although existing planning algorithms incorporate exploration rules, they fail to account for the impact of environmental features such as debris on planning and exploration, making them difficult to apply across diverse mining scenarios. In contrast, the present invention establishes a state space that considers obstacle distribution and inputs it into the deep learning network to optimize exploration parameters. This creates a mapping relationship between debris obstacles and exploration parameters, making it more suitable for complex and dynamic mining operation scenarios. Furthermore, for path planning in general unstructured environments, this algorithm also holds potential application value, and the exploration parameter optimization approach can be referenced for other search-based algorithms.

### (3) Reduction in Parameter Tuning and Maintenance Costs

In existing path planning methods, different path exploration parameters must be set and maintained in parameter tables to address various scenarios. This leads to difficulties in parameter optimization and high maintenance costs, especially given the dynamic nature of mining operation scenarios, which further exacerbates the challenges of parameter tuning and maintenance. The present invention addresses this by constructing a deep learning network to achieve adaptive optimization of path exploration parameters, eliminating the need for manual parameter tuning and thereby reducing debugging costs. Moreover, since the deep learning network considers obstacle characteristics, it exhibits stronger generalization across scenarios. When switching to new scenarios, only offline training on the new map is required, eliminating the need for manual maintenance of extensive parameter tables and reducing maintenance costs.

### (4) Experimental Validation

In experiments, the technical solution proposed in the present invention was compared with existing methods for path planning performance in mining operation scenarios. The results demonstrate that the present invention achieves superior performance in both solution efficiency and path planning length, exhibiting higher search efficiency and path quality.

Specific data are as follows:

Tests were conducted on a grid map of an actual mining loading platform using start and end points from real production data, and compared with the Hybrid A* algorithm currently applied to unmanned mining truck path planning. The solution time of the present invention was 0.43 seconds, representing an 80% reduction compared to Hybrid A*, while the path length was 437 meters, representing an 11% reduction compared to Hybrid A*, demonstrating significant superiority.

A computer device, comprising a memory and a processor, wherein the memory stores a computer program, and the processor executes the computer program to implement deep reinforcement learning-based path exploration parameter optimization method.

A non-transitory computer readable storage medium, wherein the medium stores a computer program, and the program is executed by processor to implement deep reinforcement learning-based path exploration parameter optimization method.

In summary, through theoretical analysis and experimental data, the present invention proves that the deep reinforcement learning-based path exploration parameter optimization method significantly improves search efficiency and path quality, reduces parameter tuning and maintenance costs, and is more suitable for dynamic mining environments, holding substantial practical application value.

### DESCRIPTION OF DRAWINGS

FIG. 1 is an overall structure diagram of the deep reinforcement learning-based path exploration parameter optimization system according to the present invention;

FIG. 2 is a flowchart of node exploration rules with variable parameters according to the present invention;

FIG. 3 is a schematic diagram of regional division of obstacles around a mining truck according to the present invention;

FIG. 4 is a training flowchart of the DQN network according to the present invention;

FIG. 5 is an overall flowchart of the deep reinforcement learning-based path exploration parameter optimization method according to the present invention;

FIG. 6 is a flowchart of the deep reinforcement learning-based path exploration parameter optimization algorithm according to the present invention.

### DETAILED DESCRIPTION

To make the objectives, technical solutions, and advantages of the embodiments of the present application clearer, the technical solutions in the embodiments of the present application will be described clearly and completely below in conjunction with the accompanying drawings in the embodiments of the present application. Obviously, the described embodiments are part of the embodiments of the present application, but not all of them. Based on the embodiments in the present application, all other embodiments obtained by a person of ordinary skill in the art without making creative efforts shall fall within the scope of protection of the present application.

Those skilled in the art will appreciate that unless specifically stated otherwise, the singular forms “a,” “an,” “said,” and “the” used herein may also include plural forms. It should be further understood that the term “comprising” used in the description of the present invention indicates the presence of the stated features, integers, steps, operations, elements, and/or components, but does not preclude the presence or addition of one or more other features, integers, steps, operations, elements, components, and/or groups thereof.

To achieve efficient unmanned mining truck path planning, the present invention proposes a deep reinforcement learning-based path exploration parameter optimization system and method. Firstly, a Hybrid A* path planning framework with variable exploration parameters is constructed, an environment representation model considering obstacle regional division is established, and on this basis, a deep reinforcement learning-based exploration parameter optimization strategy is developed. The specifics are as follows:

1. Path Planning Framework with Variable Exploration Parameters
(1) Node Exploration Rules with Variable Parameters

By analyzing the kinematic characteristics of the unmanned mining truck, iterative node exploration rules for path nodes are established. Key exploration parameters are extracted to construct the node exploration process with variable parameters.

### 1.1 Node Evaluation Method

Based on the child nodes generated through node exploration in section 1.1, the validity of the child nodes is analyzed via collision detection. A targeted evaluation method is established to assign a cost value to each child node, thereby obtaining the child node set.

### 1.2 Loading and Parking Path Generation Method Based on Reeds-Shepp Curve

During the iterative exploration process, terminal constraints must be considered. Multiple candidate parking paths are generated based on the Reeds-Shepp curve, screened and sorted using an evaluation function, and finally an appropriate loading and parking path is selected to conclude the search.

### 2. Environment Representation Model Considering Obstacle Regional Division

### 2.1 Obstacle Regional Division

Based on the information of the current node, the surrounding space is divided according to the mining truck model to determine the occupancy status of obstacles, thereby modeling the distribution characteristics of the obstacles.

### 2.2 Environmental State Space Modeling

Based on the regional division in section 2.1, an environmental state space for deep reinforcement learning is constructed. This state space is used to represent the state obtained by the agent from the environment and is input into the deep reinforcement learning neural network.

### 3. Exploration Parameter Optimization Method Based on Deep Reinforcement Learning

### 3.1 Deep Learning Network Construction

Based on the state space designed in section 2.2 and the exploration parameter rules in section 1.1, a neural network is constructed to achieve the mapping from the state space to the exploration parameters.

### 3.2 Reward Function Construction

Necessary indicators for path planning are analyzed, and a reward function for the agent during iterative training is constructed to guide the training of the deep reinforcement learning strategy.

### 3.3 Deep Reinforcement Learning Training Process

Based on the design of the above deep reinforcement learning modules, an offline training process is constructed to optimize the exploration parameter network.

The following is explained through specific embodiments:

### First Embodiment

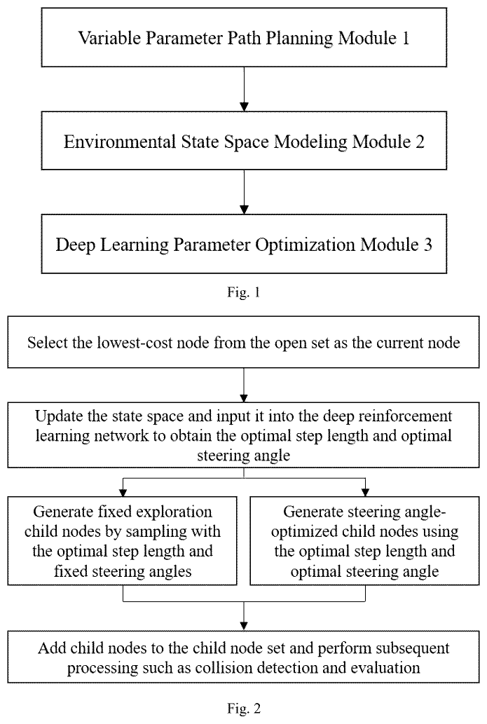

As shown in FIG. 1, this embodiment provides a deep reinforcement learning-based path exploration parameter optimization system, comprising: establishing a path planning framework with variable exploration parameters; analyzing obstacle distribution characteristics based on this framework to build an environmental state space; and finally constructing a deep reinforcement learning network to achieve adaptive optimization of path exploration parameters.

I. Variable Parameter Path Planning Module 1 for the Path Planning Framework with Variable Exploration Parameters

A variable parameter path planning module 1, configured to: generate an optimal step length and an optimal steering angle based on a deep reinforcement learning network according to a current node and environmental information; construct a fixed steering angle set; perform node exploration by generating a child node set by combining the optimal step length with the fixed steering angle set and generating a steering angle-optimized child node by combining the optimal step length with the optimal steering angle and adding it to the child node set; perform collision detection on the child nodes in the child node set and calculate cost values of all the child nodes; and finally generate a loading and parking path using a Reeds-Shepp curve.

In this embodiment, the variable parameter path planning module 1 is specifically as follows:

### Variable Parameter Exploration Rules

Node exploration must satisfy the motion characteristics constraints of the unmanned mining truck; otherwise, the mining truck cannot track the generated path, leading to significant risks. Therefore, it is first necessary to model the mining truck's motion characteristics. In the working scenario of the mining truck in this project, since the mining truck typically operates at low speeds, a two-degree-of-freedom vehicle kinematics model can be used to characterize the motion characteristics of the unmanned mining truck.

Specifically, the vehicle pose state at any given time can be represented as: q=(x, y, φ), where the coordinate origin is located at the center of the rear axle, and the coordinate axes are parallel to the vehicle body. v denotes the vehicle speed, v denotes the vehicle heading angle, δ denotes the vehicle steering angle, and L_{w} denotes the wheelbase of the vehicle. The kinematic model of the vehicle can be expressed as follows:

$$[ \begin{matrix}\dot{x} \\ \dot{y} \\ \dot{φ}\end{matrix} ] = [ \begin{matrix}cos φ \\ sin φ \\ \frac{tan φ}{{L}_{w}}\end{matrix} ] v$$

Assuming the current node is N_{c}(x_{c}, y_{c}, φ_{c}), where x_{c}, y_{c} are the coordinates and φ_{c} is the heading angle, the following is established based on the motion characteristics of the unmanned mining truck:

$$\{ \begin{matrix}{x}_{s} = {x}_{c} + d * l cos {φ}_{c} \\ {y}_{s} = {y}_{c} + d * l sin {φ}_{c} \\ {φ}_{s} = {φ}_{c} + l * \frac{tan δ}{{L}_{w}}\end{matrix} \qquad ( 1 )$$

Where Nₛ(xₛ, yₛ, φₛ) is the next child node explored from the current node, xₛ, yₛ are the position coordinates, φₛ is the heading angle, dₛ∈{−1,1} represents the expansion direction of the current node including backward or forward, δ and l represent the steering angle and step length of node expansion respectively, and L_{w} is the wheelbase of the unmanned mining truck.

It can be observed that the position and orientation of the child nodes are determined by the expansion direction, steering angle, and step length. Conventional algorithms often employ fixed steering angles and step lengths, which makes it difficult for them to adapt to complex and dynamic mining operating environments.

To achieve variable steering angles and step lengths, one can sample steering angles and step lengths to form corresponding sets A={δ₁, . . . , δ_{N}_{₁}} and L={l₁, . . . , l_{N}_{₂}}, where N₁ and N₂ represent the number of samples for each parameter. However, since the step lengths and steering angles can be combined to form N₁×N₂ possible combinations, this would lead to a significant increase in computational time. Therefore, the present invention optimizes these parameters through deep reinforcement learning and establishes exploration rules.

Specifically, as shown in FIG. 2, the optimal step length L_{best} and the optimal steering angle δ_{best} for the current node and environmental information are generated by the deep reinforcement learning network. Since the left and right steering capabilities of the mining truck are symmetric, the fixed steering angle set A₁={δ₁, . . . , δ_{N}_{₂}} is constructed using uniform sampling, where N₃ is the number of steering angle samples in the fixed steering angle exploration set (with N₃ being smaller than N₁ to reduce computational load and save time). For a fixed steering angle δᵢ (where i=1, 2, . . . , N₃), it is calculated as follows:

$${δ}_{i} = - {δ}_{max} + ( i - 1 ) * \frac{2 * {δ}_{max}}{{N}_{3} - 1} \qquad ( 2 )$$

Where δₘₐₓ is the maximum steering angle that the mining truck can execute, and N₃ is the number of steering angles constructed;

Based on the above parameters, Node exploration is performed through a two-step process comprising step size optimization and steering angle optimization. In the first step, the optimal step length L_{best} and all sampled fixed steering angles in the fixed steering angle set Δ₁ are substituted into Formula (1), thereby generating the child node set N for fixed steering angle exploration. The number of child nodes in the child node set N is the same as the number of sampled angles in the fixed steering angle set Δ₁, which is N₃. In the second step, the optimal step length L_{best} and the optimal steering angle δ_{best} are substituted into Formula (1) to generate the steering angle-optimized child node N_{best}, which is then added to the child node set N.

### Node Evaluation Method

After obtaining the child node set N, the child nodes within the set need to be evaluated. Specifically, collision detection is first performed on all child nodes in the child node set N by covering the mining truck with two enveloping circles and sampling along the path from the current node to the explored child node (a smooth circular arc generated by the turning radius corresponding to the steering angle). It is determined whether the distance to any obstacle grid is smaller than the radius of the enveloping circles; if so, the child node is considered infeasible and is removed from the child node set N;

On this basis, the cost value of all explored child nodes is calculated using f(Nₛ)=g(Nₛ)+wₕ×h(Nₛ), where g(Nₛ) represents the actual consumption cost of the mining truck moving from the starting point to the explored child node Nₛ, h(Nₛ) denotes the predicted cost from the explored child node to the target point, and wₕ is the weight of the predicted cost. When designing the cost function g(Nₛ), considerations are given to operations such as reversing and direction changes during the movement of the mining truck, which typically consume more time and energy. Therefore, this paper comprehensively incorporates factors such as reversing penalty, direction-switching penalty, and path length into the cost function to evaluate the quality of the nodes.

Wherein the actual consumption cost g(Nₛ) is:

$$g ( {N}_{s} ) = g ( {N}_{c} ) + {w}_{1} {g}_{dis} ( {N}_{s} ) + {w}_{2} {g}_{back} ( {N}_{s} ) + {w}_{3} {g}_{switch} ( {N}_{s} ) + {w}_{4} {g}_{steer} ( {N}_{s} ) + {w}_{5} {g}_{change} ( {N}_{s} ) \qquad ( 3 )$$

In the above formula, g(Nₛ) incorporates five metrics based on the cost of the current node g(N_{c}): g_{dis}(Nₛ) denotes the distance from the current node N_{c} to the child node Nₛ in the iterative search; g_{back}(Nₛ) represents the reversing cost; g_{switch}(Nₛ) indicates the mode switch cost; gₛₜₑₑᵣ(Nₛ) denotes the steering cost; g_{change}(Nₛ) represents the steering change cost; and wᵢ, where i=1, . . . ,5, are the weight coefficients.

If the child node is obtained through vehicle reversing exploration, a reversing cost g_{back}(Nₛ) is added to the cost function, typically as a relatively large constant cost; when the vehicle's movement direction is opposite to that in the previous search round, a mode switch cost g_{switch}(Nₛ) is added to the cost function, generally as a relatively large constant; if the steering angle used in the current exploration is non-zero, a steering cost gₛₜₑₑᵣ (Nₛ) is added, the magnitude of which is proportional to the absolute value of the steering angle applied; when the steering angle used in the current search differs from that in the previous round, a steering change cost g_{change}(Nₛ) is added, the magnitude of which is proportional to the absolute value of the change in the steering angle. The heuristic function h(Nₛ) is the estimated cost from the current node to the destination. In this paper, a heuristic function considering obstacles is used, specifically employing the A* method to compute the distance between the current node and the destination.

### (3) Loading and Parking Path Generation Method Based on Reeds-Shepp Curve

When the distance between the current node N_{c}(x_{c}, y_{c}, φ_{c}) and the target point N_{g} is less than a threshold Lₜ, a plurality of candidate loading and parking path curves from the current node N_{c}(x_{c}, y_{c}, φ_{c}) to the target point N_{g} are generated using the Reeds-Shepp curve. The node costs along the curves are calculated using Formula (3), and the curves are sorted based on their costs. The path with the minimum cost is selected, and the global path is obtained through backtracking. If all candidate loading and parking path curves result in collisions, the process returns to the node exploration step.

### II. Environmental State Space Modeling Module 2 for Environment State Space Modeling Considering Obstacle Regional Division

The environmental state space modeling module 2 is configured to perform regional division of obstacles surrounding the current node and conduct environmental state space modeling.

In this embodiment, the environmental state space modeling module 2 is specifically as follows:

### Obstacle Regional Division Method

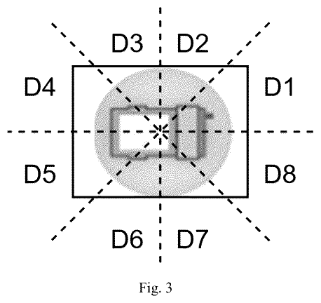

As shown in FIG. 3, to characterize the impact of environmental obstacles on planning, the present invention divides the space surrounding the current node N_{c}(x_{c}, y_{c}, φ_{c}) into 8 sectors D={D₁, . . . , D₈} by angular divisions. Within each sector, let d_{obs}_{ᵢ}(where i=1,2, . . . ,8) represent the minimum distance between obstacles and the mining truck in the i-th sector.

### Environmental State Space Modeling

Deep reinforcement learning determines the optimal action based on the input state space. Therefore, to enhance the generalization capability of the deep reinforcement learning model, it is necessary to consider the distance information between the current node and surrounding obstacles, as well as the relative positional information between the current node, the starting point, and the target point. Specifically, the state space S is designed as follows:

$$S = ( {d}_{start} , {ϕ}_{start} , {d}_{goal} , {ϕ}_{goal} , {φ}_{goal} , - ϕ , {S}_{position} , {N}_{obs} , {d}_{{obs}_{i}} ) \qquad ( 4 )$$

Wherein Sₚₒₛᵢₜᵢₒₙ represents the coordinates of the current node, dₛₜₐᵣₜ denotes the distance from the starting point relative to the current node, φₛₜₐᵣₜ indicates the relative angular orientation of the starting point in a coordinate system with the current node as the origin and the heading direction as the x-axis, d_{goal} denotes the distance from the target point relative to the current node, φ_{goal} indicates the relative angular orientation of the target point in a coordinate system with the current node as the origin and the heading direction as the x-axis, φ_{goal}−φ represents the direction of the target loading position in a coordinate system with the current node as the origin and the heading direction as the x-axis, N_{obs} denotes the number of obstacles within a given range of the current node, and d_{obs}_{ᵢ}=1,2, . . . , 8 represents the minimum distance between obstacles and the mining truck in the i-th sector.

### III. Deep Learning Parameter Optimization Module 3 for Deep Reinforcement Learning-Based Optimization

The deep learning parameter optimization module 3 is configured to construct a deep learning network to calculate the optimal step length and the optimal steering angle, build a reward function to optimize the deep learning network, and simultaneously execute the training process.

In this embodiment, the deep learning parameter optimization module 3 is specifically as follows:

### (1) Deep Learning Network Construction

The DQN algorithm is employed to train the deep learning network. The action space consists of combinations of candidate optimal step lengths δᵣₗ and candidate optimal steering angles lᵣₗ during expansion, i.e., the action space comprises all possible combinations of (δᵣₗ, lᵣₗ).

For example,

$${δ}_{rl} ∈ [ \pm 0.9 {δ}_{max} , \pm 0.8 {δ}_{max} , \pm 0.7 {δ}_{max} , \pm 0.6 {δ}_{max} , \pm 0.4 {δ}_{max} , \pm 0.3 {δ}_{max} , \pm 0.2 {δ}_{max} , \pm 0.1 {δ}_{max} , 0 , {l}_{rl} ∈ {l}_{min} , \frac{1}{3} ( 2 {l}_{min} + {l}_{max} ) , \frac{1}{3} ( {l}_{min} + 2 {l}_{max} ) , {l}_{max} ] .$$

Where lₘᵢₙ and lₘₐₓ are the minimum and maximum exploration step lengths, respectively, and can be adjusted. The action space consists of all possible combinations of δᵣₗ and lᵣₗ, resulting in a total of 17×4=68 possible actions.

The DQN algorithm utilizes two networks with identical structures but different parameters for training: a training network Q_{π} used to compute the Q-value for policy selection and iteratively update the Q-values; and a target network Q′_{π} used to compute the Q-value of the next state in the temporal difference target (TD Target). The loss function Loss of the DQN algorithm is designed as follows:

$$Loss = \frac{1}{N} {\sum }_{i} {( {r}_{i} + γ {max}_{{a}_{i}^{′}} {Q}_{π}^{′} ( {s}_{i}^{′} , {a}_{i}^{′} ) - {Q}_{π} ( {s}_{i} , {a}_{i} ) )}^{2} \qquad ( 5 )$$

Wherein (sᵢ, aᵢ, rᵢ, s′ᵢ) represents a set of state transition data obtained during training, including the current state sᵢ, the current action aᵢ, the reward rᵢ obtained after taking the actiona′ᵢ, and the next state

$${s}_{i}^{′}$$

obtained after interacting with the environment by taking the action; γ is an adjustable discount factor;

Both the target network

$${Q}_{π}^{′}$$

and the training network Q_{π} are constructed using three fully connected layers, each containing 32 neurons. The outputs of the first two fully connected layers are fed into an activation function before being passed to the next fully connected layer, with the PReLU activation function being employed. The final fully connected layer directly outputs the Q-value for each action, including steering angles and step lengths. The steering angle and step length with the highest Q-value are ultimately selected as the optimized exploration parameters, comprising the optimal step length and the optimal steering angle.

### (2) Reward Function Construction

To train and optimize the deep reinforcement learning network, it is essential to design a reasonable reward function and refine the strategy through rewards. Specifically, since path planning is an iterative search process, the deep reinforcement learning network outputs an action and receives a corresponding reward during each exploration round. The design of this reward function primarily considers guiding the mining truck to reach the target point quickly, reducing the number of iteration rounds, and maintaining a safe distance from obstacles. The designed reward function includes a target approach reward r_{g}, an obstacle avoidance reward rₒ, an exploration cost rₜ, and a smoothness reward rₛ.

r_{g} is the target approach reward, designed to guide the mining truck toward the destination. Accordingly, a positive reward is given when the mining truck moves closer to the target point, while a penalty is imposed when it moves farther away. Furthermore, when the Reeds-Shepp curve in the current round successfully connects to the destination, the mining truck is considered to have reached the target point, and a fixed arrival reward r_{success} is granted.

The target approach reward r_{g} is defined as follows:

$${r}_{g} = \{ \begin{matrix}{r}_{success} & Reeds - shepp connection success \\ {w}_{g} ( {l}_{c} - {l}_{b} ) & Reeds - shepp connection failed\end{matrix} \qquad ( 6 )$$

Wherein w_{g} is an adjustable weight, l_{c} is the Euclidean distance from the current node N_{c} to the target point N_{g} in the current iteration round, lₛ is the Euclidean distance from the steering angle-optimized child node N_{best} to the target point N_{g}, and r_{success} is a fixed reward granted when the Reeds-Shepp curve in the current round successfully connects to the destination, indicating that the mining truck has reached the target point. Triggering the Reeds-Shepp curve signifies successful path generation, thus resulting in a relatively large reward. Conversely, if the Reeds-Shepp curve fails to trigger, further exploration is still required. During node exploration, it is desirable for the nodes generated by the optimized exploration parameters to be as close as possible to the target point. Therefore, a reward component is introduced based on the difference between the distance from the current node to the target point l_{c} and the distance from the child node to the target point l_{b}. If the child node generated by the optimized exploration parameters moves farther from the target point, this reward component is negative; otherwise, it is positive.

rₒ is the obstacle avoidance reward, designed to prevent the mining truck from getting too close to surrounding obstacles and causing collisions. When designing the obstacle avoidance reward function, the safety status of the mining truck is classified into four conditions based on the distance d_{obs}_{ᵢ} between the obstacles and the generated steering angle-optimized child node N_{best}: collision, danger, risk, and safe. Furthermore, to better guide the policy training, a potential field function is employed to ensure the continuity of reward outputs at different distances.

The obstacle avoidance reward rₒ is defined as follows:

$${r}_{{o}_{i}} = \{ \begin{matrix}{r}_{collision} , {d}_{{obs}_{i}} \leq d \\ \frac{{w}_{1}}{{d}_{{obs}_{i}}} , {d}_{c} \leq {d}_{{obs}_{i}} \leq 2 {d}_{c} \\ \frac{{w}_{2}}{( {d}_{{obs}_{i}} )} , 2 {d}_{c} \leq {d}_{{obs}_{i}} \leq 10 {d}_{c} \\ 0 , else\end{matrix} \qquad ( 7 )$$

Wherein rₒ; represents the obstacle avoidance reward in the i-th sector, w₁ and w₂ are adjustable weight coefficients respectively. A distance threshold d_{c} is designed, where d_{obs}_{ᵢ}≤d_{c} is considered a collision, returning a large penalty constant r_{collision}; when d_{c}≤d_{obs}_{ᵢ}≤2d_{c}, it is considered a dangerous situation, returning a relatively large penalty function; when 2d_{c}≤d_{obs}_{ᵢ}≤10d_{c}, it is considered risky, returning a relatively small penalty function; when d_{obs}_{ᵢ}≥10d_{c}, it is considered safe, and no penalty is returned. The overall obstacle avoidance reward rₒ satisfies the following formula:

$${r}_{o} = {\sum }_{n = 1}^{8} - {r}_{{o}_{i}} \qquad ( 8 )$$

The exploration cost rₜ is defined as follows:

$${r}_{t} = - Timeconstant \qquad ( 9 )$$

Wherein TimeConstant is a fixed penalty cost constant set for each step, guiding the mining truck to approach the destination more rapidly and preventing meaningless exploration, with the cost set as a negative value;

Since steering changes in the mining truck incur additional travel costs, a smoothness reward rₛ is set in this invention to encourage minimizing steering wheel adjustments. The smoothness reward rₛ is defined as follows:

$${r}_{s} = - {w}_{3} \vert {δ}_{rl} \vert - {w}_{4} {e}^{\frac{1}{{l}_{rl}}} \vert {δ}_{rl} - {δ}_{c} \vert \qquad ( 10 )$$

Wherein δ_{c} represents the steering angle corresponding to the current node N_{c} generated in the current search iteration round, δᵣₗ corresponds to the optimal steering angle generated by the deep reinforcement learning network in the current search iteration round, lᵣₗ represents the optimal step length generated by the deep reinforcement learning network in the current search iteration round, and w₃ and w₄ are adjustable coefficients respectively;

The final reward function is as follows:

$$R = {r}_{g} + {r}_{o} + {r}_{t} + {r}_{s} \qquad ( 12 )$$

### (3) Deep Reinforcement Learning Training Process

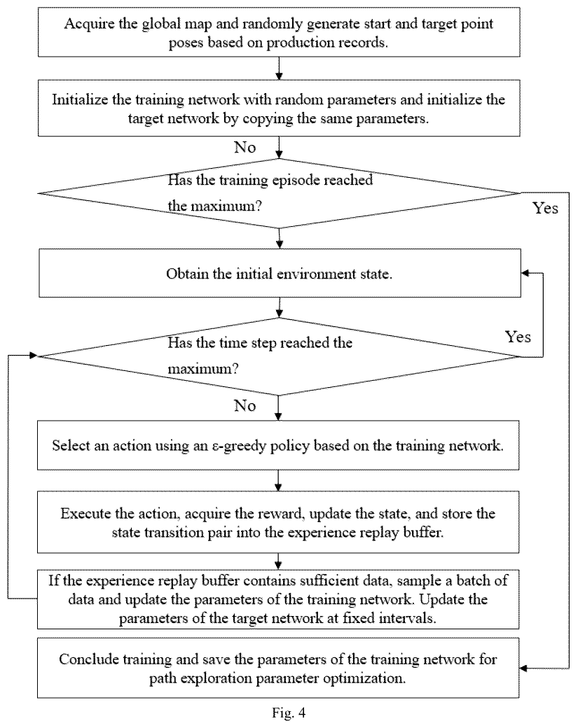

As shown in FIG. 4, for the training of deep reinforcement learning, appropriate starting and target points are first randomly selected on the map based on actual production data, and path planning is performed. During planning, path planning parameters are optimized through reinforcement learning, thereby forming multiple sets of state transition samples, which are added to a replay buffer. During training, batches of data are randomly selected from the replay buffer, and the parameters of the estimation network Q_{π} are updated according to the loss function. After a certain number of iterations, the parameters of the training network Q_{π} are copied to the target network Q′_{π}, thereby completing one learning process. Using two networks for training reduces the correlation between the current Q-value and the target Q-value to some extent, improving algorithm stability. During training, to enhance generalization, the starting and target points can be randomly fine-tuned, thereby enriching the training data and further improving generalization. The pseudo-code of the DQN algorithm used for deep reinforcement learning training is schematically shown in Table 1 below.

Table 1 DQN Algorithm
Algorithm 1 DQN Algorithm

| | |
|---|---|
| 1. | Initialize the training network Q_{π} with random parameters. |
| 2. | $Initialize the target network {Q}_{π}^{′} by copying the same parameters .$ |
| 3. | Initialize the experience replay buffer. |
| 4. | for episode e = 1 to E do |
| 5. | Obtain the initial environment state s₁. |
| 6. | for time step t = 1 to T do |
| 7. | Select an action aₜ using the ε-greedy policy based on the current |
| | network Q_{π}. |
| 8. | Execute the action aₜ, observe the reward rₜ and the next state sₜ₊₁. |
| 9. | Store the transition (sₜ, aₜ, rₜ, sₜ₊₁) in the replay buffer. |
| 10. | If the buffer contains enough samples, randomly sample a batch |
| | of transitions (sₜ, aₜ, rₜ, sₜ₊₁). |
| 11. | For each sampled transition, calculate the target value: |
| | ${y}_{i} = {r}_{i} + {Q}_{π}^{′} ( {s}_{i + 1} , π ( {s}_{i + 1} ) ) .$ |
| 12. | Update the parameters of Q_{π} to minimize the loss between |
| | Q_{π}(sᵢ, aᵢ) and y. |
| 13. | $Periodically update the target network : {Q}_{π}^{′} = {Q}_{π} .$ |

### Second Embodiment

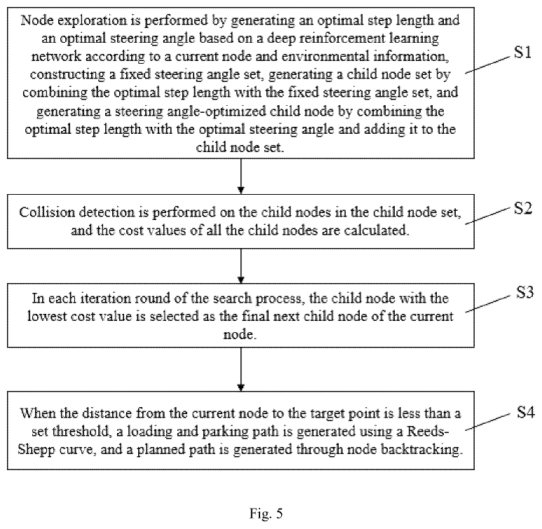

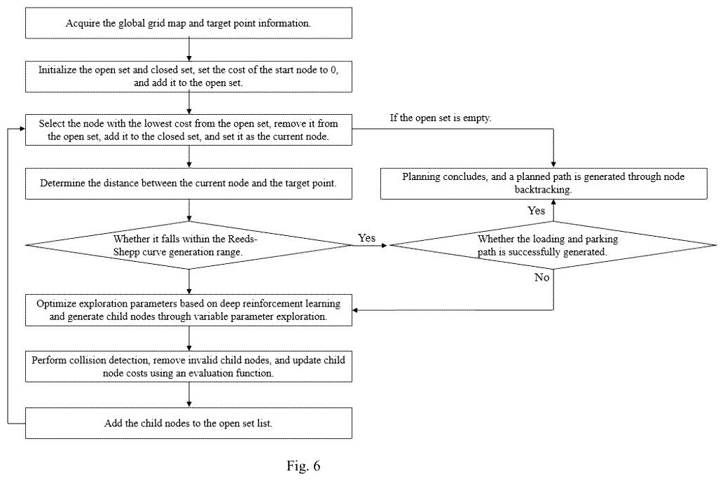

As shown in FIGS. 5 and 6, this embodiment provides a deep reinforcement learning-based path exploration parameter optimization method executed by the path exploration parameter optimization system described in the first embodiment. The method comprises the following steps:
S1: Generating an optimal step length and an optimal steering angle based on a deep reinforcement learning network according to a current node and environmental information, and constructing a fixed steering angle set; performing node exploration by combining the optimal step length with the fixed steering angle set to generate a child node set, and combining the optimal step length with the optimal steering angle to generate a steering angle-optimized child node which is added to the child node set;
S2: Performing collision detection on the child nodes in the child node set and calculating cost values of all the child nodes;
S3: Obtaining the child node with the lowest cost value in each iteration round of the search process as the final selected next node of the current node;
S4: When the distance from the current node to the target point is less than a set threshold, generating a loading and parking path using a Reeds-Shepp curve, and generating a planned path through node backtracking.

A computer-readable storage medium storing computer code, wherein when the computer code is executed, the method as described above is performed. Those of ordinary skill in the art may understand that all or part of the steps in the various methods of the above embodiments can be implemented by a program instructing relevant hardware. The program can be stored in a computer-readable storage medium, and the storage medium may include: Read-Only Memory (ROM), Random Access Memory (RAM), magnetic disks, optical discs, etc.

The foregoing descriptions are merely preferred embodiments of the present invention, and the scope of protection of the present invention is not limited to the above embodiments. All technical solutions under the concept of the present invention shall fall within the scope of protection of the present invention. It should be noted that for those skilled in the art, several improvements and modifications made without departing from the principles of the present invention should also be considered as within the scope of protection of the present invention.

The technical features of the embodiments described above can be arbitrarily combined. For the sake of brevity, not all possible combinations of the technical features in the above embodiments have been described. However, as long as there is no contradiction in the combination of these technical features, they should be considered as falling within the scope of this specification.

It should be noted that the above embodiments can be freely combined as needed. The foregoing descriptions are merely preferred embodiments of the present invention. It should be noted that for those skilled in the art, several improvements and modifications made without departing from the principles of the present invention should also be considered as within the scope of protection of the present invention.

What is claimed is:

1. A deep reinforcement learning-based path exploration parameter optimization method, comprising a non-transitory computer readable medium operable on a computer with memory for the deep reinforcement learning-based path exploration parameter optimization method, and comprising program instructions for executing the following steps of:
S1: generating an optimal step length and an optimal steering angle based on a deep reinforcement learning network according to a current node and environmental information, and constructing a fixed steering angle set; performing node exploration by combining the optimal step length with the fixed steering angle set to generate a child node set, and combining the optimal step length with the optimal steering angle to generate a steering angle-optimized child node which is added to the child node set, and
S2: performing collision detection on the child nodes in the child node set and calculating cost values of all the child nodes, and
S3: obtaining the child node with the lowest cost value in each iteration round of the search process as the final selected next node of the current node, and
S4: when the distance from the current node to the target point is less than a set threshold, generating a loading and parking path using a Reeds-Shepp curve, and generating a planned path through node backtracking; and
S5: operating mining with reducing costs and a performance efficiency based on results of the deep reinforcement learning-based path exploration parameter optimization method.

2. A deep reinforcement learning-based path exploration parameter optimization system based the deep reinforcement learning-based path exploration parameter optimization method of claim 1, characterized by comprising:
a variable parameter path planning module, configured to generate an optimal step length and an optimal steering angle based on a deep reinforcement learning network according to a current node and environmental information, construct a fixed steering angle set, perform node exploration by combining the optimal step length with the fixed steering angle set to generate a child node set and by combining the optimal step length with the optimal steering angle to generate a steering angle-optimized child node which is added to the child node set, perform collision detection on child nodes in the child node set and calculate cost values of all child nodes, and finally generate a loading and parking path using a Reeds-Shepp curve, and assuming the current node is N_{c}(x_{c}, y_{c}, φ_{c}), where x_{c}, y_{c} are the coordinates and Pc is the heading angle, the following is established based on the motion characteristics of the unmanned mining truck:
$$\{ \begin{matrix}{x}_{s} = {x}_{c} + d * l cos {φ}_{c} \\ {y}_{s} = {y}_{c} + d * l sin {φ}_{c} \\ {φ}_{s} = {φ}_{c} + l * \frac{tan δ}{{L}_{w}}\end{matrix} \qquad ( 1 )$$
where Nₛ (xₛ, yₛ, φₛ) is the next child node explored from the current node, xₛ, yₛ are the position coordinates, φₛ is the heading angle, dₛ∈{−1,1} represents the expansion direction of the current node including backward or forward, δ and l represent the steering angle and step length of node expansion respectively, and L_{w} is the wheelbase of the unmanned mining truck, and
the optimal step length generated for the current node and the environmental information by the deep reinforcement learning network, and the optimal steering angle; and the fixed steering angle set Δ₁={δ₁, . . . , δ_{N}_{₃}} is constructed by uniform sampling, and
for a fixed steering angle δᵢ (where i=1, 2, . . . , N₃), the calculation method is as follows:
$${δ}_{i} = - {δ}_{m ax} + ( i - 1 ) * \frac{2 * {δ}_{m ax}}{{N}_{3} - 1} \qquad ( 2 )$$
where δₘₐₓ is the maximum steering angle that the mining truck can execute, and N₃ is the number of steering angles constructed, and
node exploration is performed through a two-step process comprising step size optimization and steering angle optimization, and
in the first step, the optimal step length L_{best} and all sampled fixed steering angles in the fixed steering angle set Δ₁ are substituted into Formula (1), thereby generating the child node set N for fixed steering angle exploration, and
the number of child nodes in the child node set N is the same as the number of sampled angles in the fixed steering angle set Δ₁, which is N₃, and
in the second step, the optimal step length L_{best} and the optimal steering angle δ_{best} are substituted into Formula (1) to generate the steering angle-optimized child node N_{best}, which is then added to the child node set N, and
an environmental state space modeling module, configured to perform regional division of obstacles surrounding the current node and conduct environmental state space modeling, and
a deep learning parameter optimization module, configured to construct a deep learning network to calculate the optimal step length and the optimal steering angle, build a reward function to optimize the deep learning network, and simultaneously execute a training process of the deep learning network.

3. The deep reinforcement learning-based path exploration parameter optimization system according to claim 2, characterized in that, in the variable parameter path planning module, performing collision detection on the child nodes in the child node set and calculating cost values of all the child nodes specifically comprises:
performing collision detection on all child nodes in the child node set N by covering the mining truck with two enveloping circles, sampling along the path from the current node to the explored child nodes, determining whether the distance to any obstacle grid is smaller than the radius of the enveloping circles; if so, the child node is considered infeasible and is removed from the child node set N, and
the cost value of all explored child nodes is calculated using f(Nₛ)=g(Nₛ)+wₕ×h(Nₛ), where g(Nₛ) represents the actual cost consumed during the movement of the mining truck from the starting point to the explored child node, h(Nₛ) represents the estimated cost from the explored child node to the target point, and wₕ is the weight of the estimated cost, and wherein the actual consumption cost g(Nₛ) is:
$$g ( {N}_{s} ) = g ( {N}_{c} ) + {w}_{1} {g}_{dis} ( {N}_{s} ) + {w}_{2} {g}_{back} ( {N}_{s} ) + {w}_{3} {g}_{switch} ( {N}_{s} ) + {w}_{4} {g}_{steer} ( {N}_{s} ) + {w}_{5} {g}_{change} ( {N}_{s} ) \qquad ( 3 )$$
in the above formula, g(Nₛ) incorporates five metrics based on the cost of the current node g(N_{c}): g_{dis} (Nₛ) denotes the distance from the current node N_{c} to the child node Nₛ in the iterative search; g_{back}(Nₛ) represents the reversing cost; g_{switch}(Nₛ) indicates the mode switch cost; gₛₜₑₑᵣ(Nₛ) denotes the steering cost; g_{change}(Nₛ) represents the steering change cost; and wᵢ, where i=1, . . . ,5, are the weight coefficients.

4. The deep reinforcement learning-based path exploration parameter optimization system according to claim 2, characterized in that, in the variable parameter path planning module, generating the loading and parking path using a Reeds-Shepp curve specifically comprises:
when the distance between the current node N_{c}(x_{c}, y_{c}, φ_{c}) and the target point N_{g} is less than a threshold Lₜ, a plurality of candidate loading and parking path curves from the current node N_{c}(x_{c}, y_{c}, φ_{c}) to the target point N_{g} are generated using the Reeds-Shepp curve, and
the node costs along the curves are calculated by Formula (3), and the curves are sorted based on their costs, and
the path with the minimum cost is selected, and the global path is obtained through backtracking, and
if all candidate loading and parking path curves are in collision, the process proceeds to the node exploration step.

5. The deep reinforcement learning-based path exploration parameter optimization system according to claim 2, characterized in that, in the environmental state space modeling module, performing regional division of obstacles surrounding the current node specifically comprises:
the space surrounding the current node N_{c}(x, y_{c}, φ_{c}) is divided into 8 sectors D={D₁, . . . , D₈} by angular divisions, and
within each sector, let d_{obs}_{ᵢ}, where i=1,2, . . . ,8 represent the minimum distance between obstacles and the mining truck in the i-th sector.

6. The deep reinforcement learning-based path exploration parameter optimization system according to claim 5, characterized in that, in the environmental state space modeling module, conducting environmental state space modeling specifically comprises:
the state space S is defined as follows:
$$S = ( {d}_{start} , {ϕ}_{start} , {d}_{g oal} , {ϕ}_{goal} , {φ}_{goal} - ϕ , {S}_{position} , {N}_{obs} , {d}_{{obs}_{i}} ) \qquad ( 4 )$$
wherein Sₚₒₛᵢₜᵢₒₙ represents the coordinates of the current node, dₛₜₐᵣₜ denotes the distance from the starting point relative to the current node, φₛₜₐᵣₜ indicates the relative angular orientation of the starting point in a coordinate system with the current node as the origin and the heading direction as the x-axis, d_{goal} denotes the distance from the target point relative to the current node, φ_{goal} indicates the relative angular orientation of the target point in a coordinate system with the current node as the origin and the heading direction as the x-axis, φ_{goal}-φ represents the direction of the target loading position in a coordinate system with the current node as the origin and the heading direction as the x-axis, N_{obs} denotes the number of obstacles within a given range of the current node, and d_{obs}_{ᵢ}=1,2, . . . , 8 represents the minimum distance between obstacles and the mining truck in the i-th sector.

7. The deep reinforcement learning-based path exploration parameter optimization system according to claim 2, characterized in that, in the deep learning parameter optimization module, constructing the deep learning network to calculate the optimal step length and the optimal steering angle specifically comprises:
the DQN algorithm is employed to train the deep learning network, with the action space consisting of combinations of candidate optimal step lengths δᵣₗ and candidate optimal steering angles lᵣₗ during expansion, i.e., the action space comprises all possible combinations of (δᵣₗ, lᵣₗ), and the DQN algorithm utilizes two networks with identical structures but different parameters for training: a training network Q_{π} used to compute the Q-value for policy selection and iteratively update the Q-values; and a target network Q′_{π} used to compute the Q-value of the next state in the temporal difference target (TD Target), and
the loss function Loss of the DQN algorithm is designed as follows:
$$Loss = \frac{1}{N} {\sum }_{i} {( {r}_{i} + γ {max}_{{a}_{i}^{′}} {Q}_{π}^{′} ( {s}_{i}^{′} , {a}_{i}^{′} ) - {Q}_{π} ( {s}_{i} , {a}_{i} ) )}^{2} \qquad ( 5 )$$
wherein (sᵢ, aᵢ, rᵢ, s′ᵢ) represents a set of state transition data obtained during training, including the current state sᵢ, the current action aᵢ, the reward rᵢ obtained after taking the action
$${a}_{i}^{′} ,$$
and the next state
$${s}_{i}^{′}$$
obtained after interacting with the environment by taking the action; γ is an adjustable discount factor, and
both the target network
$${Q}_{π}^{′}$$
and the training network Q_{π} are constructed using three fully connected layers, each containing 32 neurons, and
the outputs of the first two fully connected layers are fed into an activation function before being passed to the next fully connected layer, with the PReLU activation function being employed, and
the final fully connected layer directly outputs the Q-value for each action, including steering angles and step lengths, and
the steering angle and step length with the highest Q-value are ultimately selected as the optimized exploration parameters, comprising the optimal step length and the optimal steering angle.

8. The deep reinforcement learning-based path exploration parameter optimization system according to claim 2, characterized in that, in the deep learning parameter optimization module, constructing a reward function to optimize the deep learning network specifically comprises:
the reward function involves a target approach reward r_{g}, an obstacle avoidance reward rₒ, an exploration cost rₜ, and a smoothness reward rₛ:
the target approach reward r_{g} is defined as follows:
$${r}_{g} = \{ \begin{matrix}{r}_{success} & Reeds - shepp connection success \\ {w}_{g} ( {l}_{c} - {l}_{b} ) & Reeds - shepp connection failed\end{matrix} \qquad ( 6 )$$
wherein w_{g} is an adjustable weight, l_{c} is the Euclidean distance from the current node N_{c} to the target point N_{g} in the current iteration round, l_{b} is the Euclidean distance from the steering angle-optimized child node N_{best} to the target point N_{g}, and r_{success} is a fixed reward given when successfully connected to the destination, indicating that the mining truck has reached the target point, and
the obstacle avoidance reward rₒ is defined as follows:
$${r}_{{o}_{i}} = \{ \begin{matrix}{r}_{collision} , & {d}_{{obs}_{i}} \leq d \\ \frac{{w}_{1}}{{d}_{{obs}_{i}}} , & {d}_{c} \leq {d}_{{obs}_{i}} \leq 2 {d}_{c} \\ \frac{{w}_{2}}{{( {d}_{{obs}_{i}} )}^{4}} , & 2 {d}_{c} \leq {d}_{{obs}_{i}} \leq 10 {d}_{c} \\ 0 , & else\end{matrix} \qquad ( 7 )$$
wherein rₒ_{ᵢ} represents the obstacle avoidance reward in the i-th sector, w₁ and w₂ are adjustable weight coefficients respectively, and
a distance threshold d_{c} is designed, where d_{obs}_{ᵢ}≤d_{c} is considered a collision, returning a large penalty constant r_{collision}; when d_{c}≤d_{obs}_{ᵢ}≤2d_{c}, it is considered a dangerous situation, returning a relatively large penalty function; when 2d_{c}≤d_{obs}_{ᵢ}≤10d_{c}, it is considered risky, returning a relatively small penalty function; when d_{obs}_{ᵢ}≥10d_{c}, it is considered safe, and no penalty is returned, and
the overall obstacle avoidance reward rₒ satisfies the following formula:
$${r}_{o} = {\sum }_{n = 1}^{8} - {r}_{{o}_{i}} \qquad ( 8 )$$
the exploration cost rₜ is defined as follows:
$${r}_{t} = - Timeconstant \qquad ( 9 )$$
wherein TimeConstant is a fixed penalty cost constant set for each step, guiding the mining truck to approach the destination more rapidly and preventing meaningless exploration, with the cost set as a negative value, and
the smoothness reward rₛ is defined as follows:
$${r}_{s} = - {w}_{3} \vert {δ}_{r l} \vert - {w}_{4} {e}^{- \frac{1}{{l}_{rl}}} \vert {δ}_{r l} - {δ}_{c} \vert \qquad ( 10 )$$
wherein δ_{c} represents the steering angle corresponding to the current node N_{c} generated in the current search iteration round, ort corresponds to the optimal steering angle generated by the deep reinforcement learning network in the current search iteration round, lᵣₗ represents the optimal step length generated by the deep reinforcement learning network in the current search iteration round, and w₃ and w₄ are adjustable coefficients respectively, and
the final reward function is as follows:
$$R = {r}_{g} + {r}_{o} + {r}_{t} + {r}_{s} . \qquad ( 12 )$$

9. The deep reinforcement learning-based path exploration parameter optimization system according to claim 7, characterized in that, in the deep learning parameter optimization module, executing the training process of the deep learning network specifically comprises:
first, randomly selecting appropriate starting and target points on the map based on actual production data and performing path planning; during planning, optimizing path planning parameters through reinforcement learning, thereby forming multiple sets of state transition sample data and adding them to a replay buffer; during the training process, randomly selecting batches of data from the replay buffer and updating the parameters of the estimation network Q_{π} according to the loss function; after a certain number of iterations, copying the parameters of the training network Q_{π} to the target networkQ′_{π}, thereby completing one learning process.
